(19) United States
(12) Patent Application Publication
(10) Pub. No.: US 2023/0238893 A1
(43) Pub. Date: Jul. 27, 2023

(54) ELECTRIC MOTOR DRIVING APPARATUS, AIR CONDITIONER, AND REFRIGERATOR

(71) Applicant: Mitsubishi Electric Corporation, Tokyo (JP)

(72) Inventors: Hiroyuki YAMASHITA, Tokyo (JP); Tomohiro KUTSUKI, Tokyo (JP); Hiroki SUZUKI, Tokyo (JP)

(21) Appl. No.: 17/915,188

(22) PCT Filed: Feb. 17, 2020
(86) PCT No.: PCT/JP2020/006100

§ 371 Date: Jan. 18, 2023

(51) Int. Cl. H02M 5/458; H02P 27/06

(52) U.S. Cl. CPC H02M 5/458; H02P 27/06

(57) ABSTRACT

A DC power supply device includes a booster circuit generating boosted voltage obtained by boosting DC voltage output from a rectifier circuit and applying the boosted voltage to an inverter circuit, a control unit controlling operation of the booster circuit, and a current detection unit detecting current flowing into and from the inverter circuit. The booster circuit includes a charge accumulation unit including first and second capacitors connected in series and first and second switching elements connected in series. The booster circuit includes a switching unit including backflow prevention elements for preventing backflow of charges from the charge accumulation unit and a current detection unit detecting current flowing into and from the booster circuit. The control unit determines whether to continue driving of an electric motor based on each of detection values of the current detection units.

### FIELD

The present disclosure relates to a direct-current (DC) power supply device that converts alternating-current (AC) power into DC power and supplies the DC power to an electric motor, an electric motor driving apparatus that drives the electric motor with the DC power supplied from the DC power supply device, and an air conditioner and a refrigerator including the electric motor driving apparatus.

### BACKGROUND

Patent Literature 1 to be described below describes a technique for detecting a short-circuit failure of one switching element in a DC power supply device that controls a full-wave rectification state and a boosted state using two switching elements connected in series.

Specifically, in Patent Literature 1, by detecting the voltage across each of two capacitors and detecting a voltage difference between the voltages across the capacitors, the failed switching element is detected. Then, at the time when a failure of a booster circuit is detected, a boosting operation is stopped and the operation shifts to a full-wave rectification operation.

### CITATION LIST

### Patent Literature

Patent Literature 1: Japanese Patent No. 6129331

### SUMMARY

### Technical Problem

In a case where a booster circuit fails, there are a case where driving can be continued and a case where driving needs to be stopped depending on a load state. However, in Patent Literature 1, a failure and a load state of an inverter circuit are not detected. Therefore, in a case of the DC power supply device using the technique in Patent Literature 1, to operate the DC power supply device safely, an electric motor needs to be stopped. That is, the technique in Patent Literature 1 has a problem in that electric motor driving is stopped although there is a case where it is possible to continue electric motor driving. Therefore, a function that enables continuation and stop of electric motor driving to be separated according to the load state has been desired.

The present disclosure has been made in view of the above, and an object thereof is to obtain a DC power supply device that enables continuation and stop of electric motor driving to be separated according to a load state.

### Solution to Problem

In order to solve the above problems and achieve the object, the present disclosure is a direct-current power supply device that converts an alternating current supplied from an alternating-current power supply into a direct current and supplies the direct current to a load including an electric motor. The direct-current power supply device includes a rectifier circuit that rectifies an alternating-current voltage output from the alternating-current power supply into a direct-current voltage. Furthermore, the direct-current power supply device includes a booster circuit that includes a reactor and generates a boosted voltage obtained by boosting the direct-current voltage output from the rectifier circuit via the reactor or without passing through the reactor and applies the boosted voltage to the load. Moreover, the direct-current power supply device includes a control unit that controls an operation of the booster circuit and a first current detection unit that detects a first current flowing between the booster circuit and the load. The booster circuit includes a charge accumulation unit that includes first and second capacitors connected in series and first and second switching elements connected in series. Furthermore, the booster circuit includes a switching unit that includes backflow prevention elements that are connected in an orientation to prevent a backflow of charges from the charge accumulation unit and a second current detection unit that detects a second current flowing between the rectifier circuit and the switching unit. The control unit determines whether or not to continue driving of an electric motor based on each of detection values of the first and second current detection units.

### Advantageous Effects of Invention

According to a DC power supply device according to the present disclosure, an effect is achieved whereby it is possible to separate continuation and stop of electric motor driving according to a load state.

### BRIEF DESCRIPTION OF DRAWINGS

FIG. 1 is a diagram illustrating an exemplary configuration of an electric motor driving apparatus including a DC power supply device according to a first embodiment.

FIG. 2 is a flowchart illustrating an example of a control procedure according to the first embodiment.

FIG. 3 is a block diagram illustrating an example of a hardware configuration that implements each function of a control unit and a driving control unit according to the first embodiment.

FIG. 4 is a block diagram illustrating another example of the hardware configuration that implements each function of the control unit and the driving control unit according to the first embodiment.

FIG. 5 is a diagram illustrating an exemplary configuration of an air conditioner according to a second embodiment.

### DESCRIPTION OF EMBODIMENTS

### First Embodiment

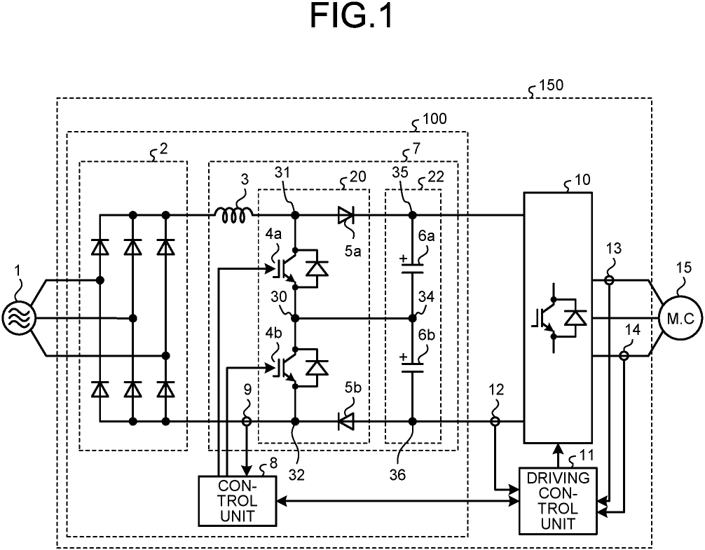

FIG. 1 is a diagram illustrating an exemplary configuration of an electric motor driving apparatus including a DC power supply device according to a first embodiment. An electric motor driving apparatus 150 according to the first embodiment includes a DC power supply device 100, an inverter circuit 10, a driving control unit 11, and current detection units 12, 13, and 14.

The DC power supply device 100 is a power conversion device that converts AC into DC. The DC power supply device 100 converts three-phase AC supplied from a power supply 1 into DC and supplies the DC to the inverter circuit 10. The inverter circuit 10 is a power conversion device that converts DC into three-phase AC. The inverter circuit 10 drives an electric motor 15 using direct current supplied from the DC power supply device 100.

As viewed from the DC power supply device 100, the inverter circuit 10 and the electric motor 15 correspond to a load that consumes DC power. That is, the DC power supply device 100 is a power supply device that supplies DC power to the load including the electric motor 15.

In general, the load including the inverter circuit is referred to as an inverter load. An example of the inverter load is a refrigeration cycle applied device. As the refrigeration cycle applied device, an air conditioner, a freezing machine, a washing and drying machine, a refrigerator, a dehumidifier, a heat-pump water heater, a showcase, and the like are exemplified. Note that the inverter load is not limited to the refrigeration cycle applied device and may be a vacuum cleaner, a fan motor, a fan, a hand dryer, an induction heating electromagnetic cooking device, or the like.

The current detection unit 12 detects current flowing into and from the inverter circuit 10, that is, current flowing between a booster circuit 7 and the inverter circuit 10. Note that, in the following description, the current flowing into and from the inverter circuit 10 is referred to as a “first current” and the current detection unit 12 is referred to as a “first current detection unit” in some cases.

The current detection units 13 and 14 detect currents flowing into the electric motor 15. The driving control unit 11 controls an operation of the inverter circuit 10 based on the first current detected by the current detection unit 12 and the currents detected by the current detection units 13 and 14.

Note that a detection method by the current detection units 12, 13, and 14 may be a method using a shunt resistance or a method using a current transformer. Furthermore, methods other than these may be used.

The DC power supply device 100 includes a rectifier circuit 2, the booster circuit 7, and a control unit 8. Note that, in FIG. 1, although the current detection unit 12 is illustrated as a configuration unit outside the DC power supply device 100, the current detection unit 12 may be configured as a configuration unit in the DC power supply device 100.

An input side of the rectifier circuit 2 is connected to the power supply 1, and an output side of the rectifier circuit 2 is connected to the booster circuit 7. The power supply 1 is an AC power supply that outputs three-phase AC. The rectifier circuit 2 rectifies an AC voltage output from the power supply 1 into a DC voltage.

The booster circuit 7 includes a reactor 3, a current detection unit 9, a switching unit 20, and a charge accumulation unit 22.

The booster circuit 7 generates a boosted voltage obtained by boosting the DC voltage output from the rectifier circuit 2 via the reactor 3 and applies the boosted voltage to the inverter circuit 10.

The current detection unit 9 detects current flowing into and from the booster circuit 7, that is, current flowing between the rectifier circuit 2 and the booster circuit 7. Note that, in the following description, the current flowing into and from the booster circuit 7 is referred to as a “second current” and the current detection unit 9 is referred to as a “second current detection unit” in some cases.

The control unit 8 controls an operation of the booster circuit 7 based on a detection value of the second current detected by the current detection unit 9.

Note that a detection method by the current detection unit 9 may be a method using a shunt resistance or a method using a current transformer. Furthermore, methods other than these may be used.

The charge accumulation unit 22 includes a first capacitor 6a and a second capacitor 6b that are connected in series between output terminals to the inverter circuit 10. The switching unit 20 includes a first switching element 4a and a second switching element 4b that are connected in series and backflow prevention elements 5a and 5b that are connected in an orientation to prevent a backflow of charges from the charge accumulation unit 22. The switching unit 20 selectively charges one or both of the first capacitor 6a and the second capacitor 6b. This control is performed by the control unit 8.

Note that, in FIG. 1, an example is illustrated in which the reactor 3 is connected to the output side of the rectifier circuit 2. However, the present disclosure is not limited to this. The reactor 3 may be connected to the input side of the rectifier circuit 2. In a case of this configuration, the booster circuit 7 generates a boosted voltage obtained by boosting the DC voltage output from the rectifier circuit 2 without passing through the reactor 3.

An example of the rectifier circuit 2 is a three-phase full-wave rectifier circuit in which six rectifier elements are full-bridge connected. Note that FIG. 1 is an example of a case where the power supply 1 is an AC power supply that outputs three-phase AC. In a case where the power supply 1 is an AC power supply that outputs singlephase AC, it is sufficient to use a full-wave rectifier circuit in which four rectifier elements are bridgeconnected.

The switching unit 20 has a midpoint 30 and connection points 31 and 32. The midpoint 30 is a connection point between the first switching element 4a and the second switching element 4b. The connection point 31 is a connection point on a high potential side of the first switching element 4a. A collector of the first switching element 4a is connected to the connection point 31. The connection point 32 is a connection point on a low potential side of the second switching element 4b. An emitter of the second switching element 4b is connected to the connection point 32.

The charge accumulation unit 22 has a midpoint 34 and connection points 35 and 36. The midpoint 34 is a connection point between the first capacitor 6a and the second capacitor 6b. The connection point 35 is a connection point on a high potential side of the first capacitor 6a. The connection point 36 is a connection point on a low potential side of the second capacitor 6b.

An anode of the backflow prevention element 5a is connected to the connection point 31, and a cathode of the backflow prevention element 5a is connected to the connection point 35. That is, the backflow prevention element 5a is connected between the connection points 31 and 35 such that a direction toward the connection point 35 is a forward direction. An anode of the backflow prevention element 5b is connected to the connection point 36, and a cathode of the backflow prevention element 5b is connected to the connection point 32. That is, the backflow prevention element 5b is connected between the connection points 36 and 32 such that a direction toward the connection point 32 is a forward direction.

Capacities of the first capacitor 6a and the second capacitor 6b are the same. As the first switching element 4a and the second switching element 4b, for example, a semiconductor element such as a power transistor, a power metal oxide semiconductor field effect transistor (MOSFET), or an insulated gate bipolar transistor (IGBT) is used.

Furthermore, the first switching element 4a and the second switching element 4b, the backflow prevention elements 5a and 5b, rectifier elements configuring the rectifier circuit 2, and switching elements configuring the inverter circuit 10 are generally formed using semiconductor elements formed of a silicon material. However, the present disclosure is not limited to this. Among these semiconductor elements, at least one of the first switching element 4a and the second switching element 4b, at least one of the backflow prevention elements 5a and 5b, the rectifier elements configuring the rectifier circuit 2, or the switching elements configuring the inverter circuit 10 may be switching elements formed of a wide band gap (WBG) semiconductor such as silicon carbide, gallium nitride, gallium oxide, or diamond.

Generally, the WBG semiconductors have lower loss than silicon semiconductors. Therefore, by forming these semiconductor elements using the WBG semiconductors, it is possible to configure a device with a low loss. Furthermore, the WBG semiconductors have a higher withstand voltage than silicon semiconductors. Therefore, the withstand voltage and an allowable current density of the semiconductor element increase, and it is possible to miniaturize a semiconductor module in which semiconductor switching elements are incorporated. Moreover, since the WBG semiconductors have a high heat resistance, a heat dissipation unit that dissipates heat generated in the semiconductor module can be miniaturized, and a heat dissipation structure for dissipating heat generated in the semiconductor module can be simplified.

Next, boosting control performed by the DC power supply device 100 will be described. The control unit 8 performs switching control on the first switching element 4a and the second switching element 4b. The switching control is described in Patent Literature 1 in detail, and detailed description here is omitted. Through the switching control performed by the control unit 8, the boosted voltage boosted by the booster circuit 7 is applied to the inverter circuit 10.

The current detection unit 9 detects the second current flowing into and from the booster circuit 7 and feeds back the second current to the control unit 8. The control unit 8 compares a detection value of the second current with a preset determination value. In a case where the detection value of the second current exceeds the determination value, the control unit 8 determines that overcurrent has flowed in the booster circuit 7 and sets a status of the booster circuit 7 to failure. Hereinafter, this failure is appropriately referred to as an “overcurrent failure”. In a case when the control unit 8 detects the overcurrent failure of the booster circuit 7, the control unit 8 stops the switching control on the first switching element 4a and the second switching element 4b of the switching unit 20.

As described above, the driving control unit 11 controls the operation of the inverter circuit 10 based on the first current detected by the current detection unit 12 and the currents detected by the current detection units 13 and 14 and drives the electric motor 15.

The driving control unit 11 determines a load state of the electric motor 15 based on current values of the currents detected by the current detection units 13 and 14. If the current value of the detected current is larger than a threshold, it can be determined that driving is performed with a high load. In contrast, if the current value of the detected current is smaller than the threshold, it can be determined that driving is performed with a low load. Here, whether the electric motor 15 is in a high load state or a low load state is determined using one threshold. However, the load state may be determined in multiple stages using two or more thresholds. Furthermore, the threshold may be unfixed, and may be variable according to an operation state of the electric motor 15.

Furthermore, the driving control unit 11 may determine a voltage value of the direct current applied to the inverter circuit 10 based on the load state of the electric motor 15. The driving control unit 11 transmits information regarding the determined voltage value to the control unit 8. The control unit 8 controls an on-time of the first switching element 4a and the second switching element 4b based on the information regarding the voltage value transmitted from the driving control unit 11 and controls the voltage value of the direct current applied to the inverter circuit 10.

Moreover, the driving control unit 11 detects the first current flowing into and from the inverter circuit 10 and compares the detection value of the first current with a preset determination value. In a case where the detection value of the first current exceeds the determination value, the driving control unit 11 determines that overcurrent flows in the inverter circuit 10 and sets the status of the inverter circuit 10 to failure. As in the booster circuit 7, this failure is appropriately referred to as an “overcurrent failure”. In a case when the driving control unit 11 detects the overcurrent failure of the inverter circuit 10, the driving control unit 11 stops switching control on the switching elements of the inverter circuit 10.

Note that, even in a case where the overcurrent failure occurs in the booster circuit 7, if the inverter circuit 10 is normal, it is possible to continue driving of the electric motor 15 by taking into consideration the characteristics of the electric motor 15.

In general, a driving operation range of the electric motor 15 changes depending on the DC voltage input to the inverter circuit 10. For example, in a case where the electric motor 15 is an electric motor using a permanent magnet for a rotor, this DC voltage affects magnet characteristics of the permanent magnet used for the rotor.

A permanent magnet electric motor is known that uses, for example, a rare-earth magnet with a strong magnetic force as a material of the permanent magnet. Since the rare-earth magnet has a strong magnetic force, a torque is generated with a small current. Therefore, the rare-earth magnet is often applied to an electric motor used for a device that requires energy saving. However, because the rare-earth magnet is rare metal called rare-earth, it is difficult to obtain the rare-earth magnet. In a permanent magnet electric motor that does not use the rare-earth magnet but uses a magnet such as ferrite with a weaker magnetic force than the rare-earth magnet, if the current is the same, an output torque is smaller than that in a case where the rare-earth magnet is used. Therefore, the permanent magnet electric motor using the magnet such as the ferrite with a weak magnetic force needs to compensate a torque by increasing the current by the decrease in the magnetic force of the magnet. Alternatively, because the output torque is proportional to (the current)×(the number of turns of winding), it is necessary to compensate the output torque by increasing the number of turns and without increasing the current. When the current is increased, a copper loss in the electric motor 15 and a conduction loss in the inverter circuit 10 increase.

In a case where the number of turns of stator windings is increased without increasing the current in order to avoid the increase in the loss in the electric motor 15, an induced voltage of the electric motor 15 increases according to the rotation speed of the electric motor 15. In a case where the electric motor 15 is driven, the inverter circuit 10 needs to apply a DC voltage higher than the induced voltage to the electric motor 15. Therefore, in a case where the number of turns of the stator windings is increased, it is necessary to increase the DC voltage to be applied to the electric motor 15.

In a case where the electric motor 15 is operated with a high load, a high rotation speed is needed. On the other hand, in a case of a low load operation, a high rotation speed is not needed, and it is possible to drive the electric motor 15 with a low rotation speed. That is, in the low load operation, there is a case where the electric motor 15 can be driven without increasing the DC voltage to be applied to the electric motor 15.

As can be understood from the above description, the DC power supply device 100 and the electric motor driving apparatus 150 according to the first embodiment are suitable for a case of driving the electric motor having the permanent magnet that is formed of a material other than rare-earth elements.

Note that, in the above, it has been described that the control unit 8 determines the overcurrent failure of the booster circuit 7 and the driving control unit 11 determines the overcurrent failure of the inverter circuit 10. However, the present disclosure is not limited to this. The control unit 8 may be set as a high-order control unit, and the control unit 8 may determine the overcurrent failures of the booster circuit 7 and the inverter circuit 10. Information needed for the determination by the control unit 8 can be realized by receiving the information via the driving control unit 11.

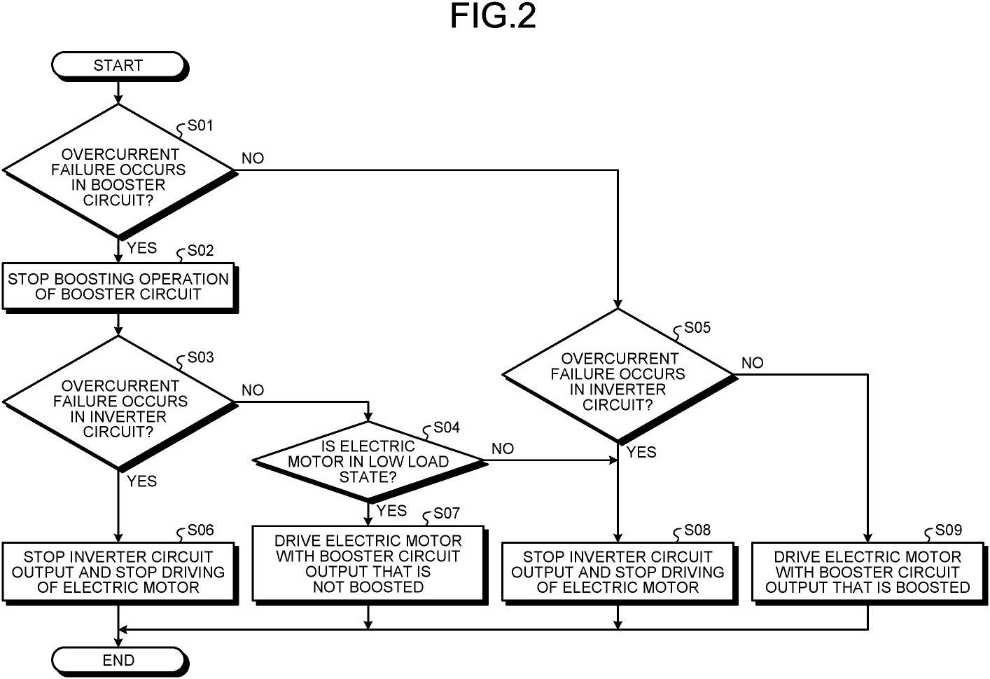

Next, a control procedure according to the first embodiment for separating continuation and stop of electric motor driving will be described with reference to FIGS. 1 and 2. FIG. 2 is a flowchart illustrating an example of the control procedure according to the first embodiment. Note that each processing in FIG. 2 is assumed to be performed under control of the control unit 8 in the description.

First, the control unit 8 determines whether or not an overcurrent failure occurs in the booster circuit 7 (step S01). In a case where the overcurrent failure in the booster circuit 7 is detected (step S01, Yes), a boosting operation of the booster circuit 7 is stopped (step S02), and the procedure proceeds to step S03. The control unit 8 determines whether or not the overcurrent failure occurs in the inverter circuit 10 (step S03). If the overcurrent failure in the inverter circuit 10 is detected (step S03, Yes), the control unit 8 stops an output of the inverter circuit 10 (step S06) and the flow in FIG. 2 ends.

Furthermore, in step S03, if the overcurrent failure in the inverter circuit 10 is not detected (step S03, No), the load state of the electric motor 15 is determined (step S04). If the load state of the electric motor 15 is not a low load state (step S04, No), the output of the inverter circuit 10 is stopped (step S08) and the flow in FIG. 2 ends. On the other hand, if the load state of the electric motor 15 is a low load state (step S04, Yes), it is selected to continue driving of the electric motor 15 with an output of the booster circuit 7 that is not boosted, that is, a non-boosted voltage output from the booster circuit 7 (step S07), and the flow in FIG. 2 ends. Note that the load state of the electric motor 15 in step S04 can be determined based on the current values of the currents detected by the current detection units 13 and 14.

Returning to step S01, in a case where the overcurrent failure in the booster circuit 7 is not detected (step S01, No), the procedure proceeds to step S05. The control unit 8 determines whether or not the overcurrent failure occurs in the inverter circuit 10 (step S05). If the overcurrent failure in the inverter circuit 10 is detected (step S05, Yes), the control unit 8 stops an output of the inverter circuit 10 (step S08) and the flow in FIG. 2 ends. When the overcurrent failure in the inverter circuit 10 is not detected (step S05, No), it is selected to continue driving of the electric motor 15 with the output of the booster circuit 7 that has been boosted (step S09) and the flow in FIG. 2 ends.

By performing the processing procedure in FIG. 2, it is possible to separate continuation and stop of electric motor driving. As a result, it is possible to solve a problem that electric motor driving is stopped although there is a case where electric motor driving can still be continued. Furthermore, in a case where the DC power supply device 100 and the electric motor driving apparatus 150 according to the first embodiment are applied to, for example, an air conditioner and a refrigerator, it is possible to configure the air conditioner and the refrigerator as products with higher comfort.

As described above, according to the first embodiment, the first current detection unit detects the first current flowing between the booster circuit and the load, and the second current detection unit detects the second current flowing between the rectifier circuit and the switching unit. Because the control unit determines whether or not to continue driving of the electric motor based on each of the detection values of the first and second current detection units, it is possible to separate continuation and stop of electric motor driving. As a result, it is possible to solve a problem that electric motor driving is stopped although there is a case where electric motor driving can still be continued.

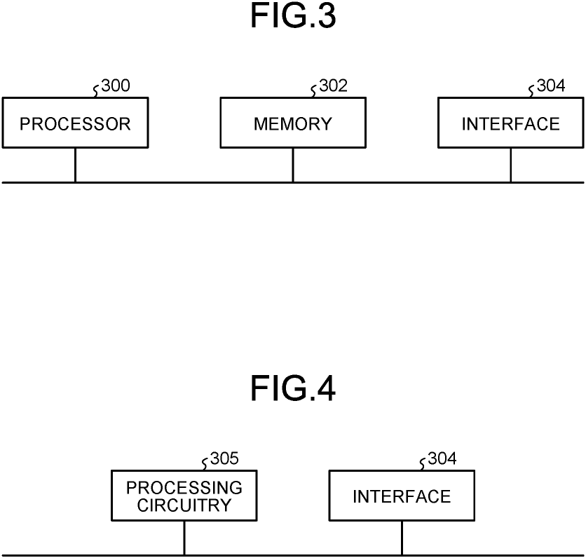

Next, a hardware configuration for implementing each function of the control unit 8 and the driving control unit 11 according to the first embodiment will be described with reference to the drawings in FIGS. 3 and 4. FIG. 3 is a block diagram illustrating an example of the hardware configuration for implementing each function of the control unit 8 and the driving control unit 11 according to the first embodiment. FIG. 4 is a block diagram illustrating another example of the hardware configuration for implementing each function of the control unit 8 and the driving control unit 11 according to the first embodiment.

In a case where some or all of each function of the control unit 8 and the driving control unit 11 according to the first embodiment are implemented, as illustrated in FIG. 3, a configuration can be used that includes a processor 300 that performs calculations, a memory 302 that saves a program to be read by the processor 300, and an interface 304 that inputs and outputs signals.

The processor 300 may be calculation means such as a calculation device, a microprocessor, a microcomputer, a central processing unit (CPU), or a digital signal processor (DSP). Furthermore, as the memory 302, a nonvolatile or a volatile semiconductor memory such as a random access memory (RAM), a read only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD) can be exemplified.

The memory 302 stores a program that executes each function of the control unit 8 and the driving control unit 11 according to the first embodiment. The processor 300 can execute the above processing by receiving needed information via the interface 304, executing the program stored in the memory 302 by the processor 300, and referring to a table stored in the memory 302 by the processor 300. A calculation result by the processor 300 can be stored in the memory 302.

Furthermore, in a case where a part of each function of the control unit 8 and the driving control unit 11 according to the first embodiment is implemented, processing circuitry 305 illustrated in FIG. 4 can be used. The processing circuitry 305 corresponds to a single circuit, a composite circuit, an application specific integrated circuit (ASIC), a field-programmable gate array (FPGA), or a combination thereof. Information input to the processing circuitry 305 and information output from the processing circuitry 305 can be obtained via the interface 304.

Note that a part of the processing of the control unit 8 and the driving control unit 11 may be executed by the processing circuitry 305 and processing that is not executed by the processing circuitry 305 may be executed by the processor 300 and the memory 302.

### Second Embodiment

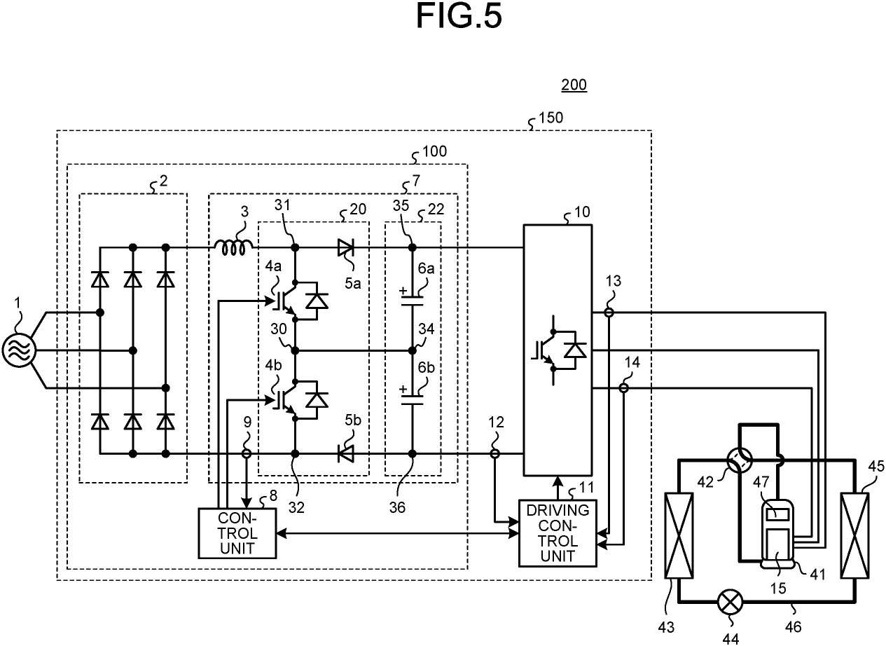

FIG. 5 is a diagram illustrating an exemplary configuration of an air conditioner according to a second embodiment. An air conditioner 200 according to the second embodiment illustrated in FIG. 5 includes the electric motor driving apparatus 150 described in the first embodiment. Specifically, the air conditioner 200 configures a separate-type air conditioner including a refrigeration cycle in which a compressor 41 including the electric motor 15 illustrated in FIG. 1, a four-way valve 42, an outdoor heat exchanger 43, an expansion valve 44, and an indoor heat exchanger 45 are attached via a refrigerant pipe 46.

In the compressor 41, a compression mechanism 47 that compresses a refrigerant and the electric motor 15 that operates the compression mechanism 47 are provided. As a result, a refrigeration cycle is configured that performs cooling and heating by circulating the refrigerant from the compressor 41 between the outdoor heat exchanger 43 and the indoor heat exchanger 45. Note that the refrigeration cycle illustrated in FIG. 5 is applicable to a device that includes the refrigeration cycle such as a refrigerator or a freezer, in addition to the air conditioner.

The air conditioner 200 that performs cooling and heating is in a stable state if the indoor temperature approaches the set temperature set by a user with the refrigeration cycle. At this time, the inverter circuit 10 operates such that the electric motor 15 installed in the compressor 41 rotates at a low speed. Therefore, in the air conditioner 200, since the low-speed rotation is continued for a long time, efficiency improvement at the time of the low-speed operation largely contributes to energy saving. Therefore, if an electric motor using a rare-earth magnet or a permanent magnet with a weak magnetic force and an increased number of turns so as to reduce the current is used as the electric motor 15, it is possible to contribute to energy saving.

Furthermore, in the second embodiment, as described in the first embodiment, even in a case where the overcurrent failure occurs in the booster circuit 7, if the inverter circuit 10 is normal, control for continuing driving of the refrigeration cycle is performed. As a result, in a case where the refrigeration cycle according to the second embodiment is applied to, for example, an air conditioner, it is possible to continue the cooling operation or the heating operation, and it is possible to buy time before repair of a failure or repurchase of a product while maintaining comfort. Furthermore, in a case where the refrigeration cycle according to the second embodiment is applied to, for example, a refrigerator, it is possible to buy time before food is damaged, and it is possible to prevent a damage caused by a failure in advance.

The configurations illustrated in the above embodiments indicate an example and can be combined with other known technique. Furthermore, the configurations illustrated in the embodiments can be partially omitted or changed without departing from the scope.

### REFERENCE SIGNS LIST

1 power supply; 2 rectifier circuit; 3 reactor; 4a first switching element; 4b second switching element; 5a, 5b backflow prevention element; 6a first capacitor; 6b second capacitor; 7 booster circuit; 8 control unit; 9, 12, 13, 14 current detection unit; 10 inverter circuit; 11 driving control unit; 15 electric motor; 20 switching unit; 22 charge accumulation unit; 30, 34 midpoint; 31, 32, 35, 36 connection point; 41 compressor; 42 four-way valve; 43 outdoor heat exchanger; 44 expansion valve; 45 indoor heat exchanger; 46 refrigerant pipe; 47 compression mechanism; 100 DC power supply device; 150 electric motor driving apparatus; 200 air conditioner; 300 processor; 302 memory; 304 interface; 305 processing circuitry.

1. An electric motor driving apparatus comprising:
a direct-current power supply device to convert an alternating current supplied from an alternating-current power supply into a direct current;
an inverter circuit to drive an electric motor using a direct current supplied from the direct-current power supply device; and
driving control circuitry to control an operation of the inverter circuit based on a first current flowing between the direct-current power supply device and the inverter circuit and a current flowing in the electric motor, wherein
the direct-current power supply device comprises:
a rectifier circuit to rectify an alternating-current voltage output from the alternating-current power supply into a direct-current voltage;
a booster circuit including a reactor, to generate a boosted voltage obtained by boosting the direct-current voltage output from the rectifier circuit via the reactor or without passing through the reactor and apply the boosted voltage to the inverter circuit;
control circuitry to control an operation of the booster circuit; and
a first current detector to detect the first current, wherein
the booster circuit comprises:
charge accumulation circuitry that includes first and second capacitors connected in series;
switching circuitry that includes first and second switching elements connected in series and backflow prevention elements that are connected in an orientation to prevent a backflow of charges from the charge accumulation circuitry; and
a second current detector to detect a second current flowing between the rectifier circuit and the switching circuitry,
the driving control circuitry determines a load state of the electric motor based on the current flowing in the electric motor and determines a voltage value of a direct current to be applied to the inverter circuit based on the load state of the electric motor,
the control circuitry controls the voltage value of the direct current to be applied to the inverter circuit based on information regarding the voltage value transmitted from the driving control circuitry,
the control circuitry detects whether or not an overcurrent failure occurs in the inverter circuit based on the detection value of the first current detector, and determines whether or not an overcurrent failure occurs in the booster circuit based on the detection value of the second current detector, in a case where the overcurrent failure in the booster circuit is detected, the control circuitry stops a boosting operation of the booster circuit, and
even in a case where the overcurrent failure in the booster circuit is detected, when the overcurrent failure in the inverter circuit is not detected,
in a case where the overcurrent failure in the booster circuit is detected, the overcurrent failure in the inverter circuit is not detected, and the load state of the electric motor is a low load state, the control circuitry continues driving of the electric motor with a non-boosted voltage output from the booster circuit.

2. (canceled)

3. The electric motor driving apparatus according to claim 1, wherein
at least one of the first and second switching elements, at least one of the backflow prevention elements, or a rectifier element included in the rectifier circuit is formed of a wide band gap semiconductor.

4-6. (canceled)

7. The electric motor driving apparatus according to claim 1, wherein
in a case where the overcurrent failure in the booster circuit is detected, when the overcurrent failure in the inverter circuit is detected, the control circuitry stops an output of the inverter circuit.

8. (canceled)

9. The electric motor driving apparatus according to claim 1, wherein
the electric motor is an electric motor including a permanent magnet formed of a material other than rare-earth elements.

10. The electric motor driving apparatus according to claim 1, wherein
a switching element configuring the inverter circuit is formed of a wide band gap semiconductor.

11. The electric motor driving apparatus according to claim 3, wherein
the wide band gap semiconductor is silicon carbide, gallium nitride, gallium oxide, or diamond.

12. An air conditioner comprising:
the electric motor driving apparatus according to claim 1; and
a compressor including an electric motor driven by the electric motor driving apparatus.

13. A refrigerator comprising:
the electric motor driving apparatus according to claim 1; and
a compressor including an electric motor driven by the electric motor driving apparatus.

14. The electric motor driving apparatus according to claim 1, wherein
even in a case where the overcurrent failure in the booster circuit is detected and the overcurrent failure in the inverter circuit is not detected, when the load state of the electric motor is not a low load state, the control circuitry stops an output of the inverter circuit.

15. The electric motor driving apparatus according to claim 10, wherein
the wide band gap semiconductor is silicon carbide, gallium nitride, gallium oxide, or diamond.
